(19) United States
(12) Patent Application Publication
(10) Pub. No.: US 2005/0008274 A1
(43) Pub. Date: Jan. 13, 2005

(54) Roller bearing with cushioned track

(75) Inventors: Michael Helbig, Esslingen (DE); Jorg Egelhaaf, Aalen (DE)

Correspondence Address: THE FIRM OF KARL F ROSS, 5676 RIVERDALE AVENUE, PO BOX 900, RIVERDALE (BRONX), NY, 10471-0900, US

(73) Assignee: Franke & Heydrich KG

(21) Appl. No.: 10/886,032

(22) Filed: Jul. 6, 2004

(30) Foreign Application Priority Data
Jul. 9, 2003 (DE) 10331150.5

(51) Int. Cl. F16C 33/60; F16C 33/58

(52) U.S. Cl. 384/516

(57) ABSTRACT

A pair of parts rotatable relative to each other about an axis are relatively supported by a roller bearing having a radially directed and angularly extending annular track unitarily formed on one of the parts and centered on the axis. The other of the parts is formed with a groove open toward the track and holding a track ring centered on the axis and formed with an annular track radially confronting the track of the one part and a cushion ring supporting the track ring in the groove on the other of the parts. An annular array of roller elements is provided between and engaging both of the tracks.

### FIELD OF THE INVENTION

The present invention relates to a roller bearing. More particularly this invention concerns a roller bearing having cushioned tracks.

### BACKGROUND OF THE INVENTION

A roller bearing is typically used to support one part on another for relative rotation about an axis, e.g. an annular rotor on a stator shaft. To this end both parts are formed with grooves provided in turn with track rings each formed with an annular track centered on the axis. An annular array of roller elements, typically balls or cylindrical rollers, is provided between the tracks, and a cage may be provided to maintain a desired angular spacing between adjacent roller elements. The tracks can confront each other radially and/or axially for transmission of radial and/or axial forces between the two parts.

In order to reduce shock transmission and even to electrically isolate the two parts from each other, it is standard to provide cushion rings of elastomeric or resilient material, normally plastic, between the track rings and the floors of the groove in which the rings is set. The cushion rings thus make the bearing tighter, as they can be compressed to prestress the balls in the tracks, and they can also serve to electrically isolate the parts from each other. In even a simple bearing there are, however, two track rings, two cushion rings, and the array of roller elements. As a result the assembly is fairly expensive and somewhat bulky.

### OBJECTS OF THE INVENTION

It is therefore an object of the present invention to provide an improved roller bearing.

Another object is the provision of such an improved roller bearing which overcomes the above-given disadvantages, that is which is of simple and inexpensive construction, yet which offers the advantages of a prestressed and isolating bearing of the type described above.

### SUMMARY OF THE INVENTION

A pair of parts rotatable relative to each other about an axis are relatively supported by a roller bearing having according to the invention a radially directed and angularly extending annular track unitarily formed on one of the parts and centered on the axis. The other of the parts is formed with a groove open toward the track and holding a track ring centered on the axis and formed with an annular track radially confronting the track of the one part and a cushion ring supporting the track ring in the groove on the other of the parts. An annular array of roller elements is provided between and engaging both of the tracks.

The instant invention is based on the surprising discovery that only a single cushion ring is needed to provide all the electrical isolation and prestressing that most situations require. By forming one of the tracks directly on the one part, typically by turning and hardening, it is possible to dispense with the second cushion ring and track ring. The result is a bearing that performs like the more complex prior-art bearings, but that is simpler to manufacture and assemble. The bearing according to the invention runs quietly and has an excellent service life.

The tracks in accordance with the invention are hardened. They can be formed by machining or cast in place.

The one part according to the invention is a rotor and the other part is a stator.

In one system according to the invention the one part is formed with two such tracks spaced axially apart and the bearing has two such track rings in the groove and two such cushion rings between the track rings and the other part. The array of roller element rides on both tracks of the one part and both track rings of the other part. In this system the one part can be subdivided axially into two subparts between the two tracks.

In another system according to the invention the one part is formed with two such tracks spaced axially apart and the other part is formed with two such grooves spaced axially apart. The bearing has two such track rings in the grooves, two such cushion rings between the track rings and the other part, and two such arrays of roller elements. Here also the one part can be subdivided axially into two subparts between the two tracks.

The two subparts can be relatively axially displaceable to make it possible to adjust the precompression of the cushion ring or rings.

### BRIEF DESCRIPTION OF THE DRAWING

The above and other objects, features, and advantages will become more readily apparent from the following description, reference being made to the accompanying drawing in which:

FIG. 1 is an axial section through a bearing according to the invention; and

FIGS. 2, 3, and 4 are views like FIG. 1 of different bearings in accordance with the invention.

### SPECIFIC DESCRIPTION

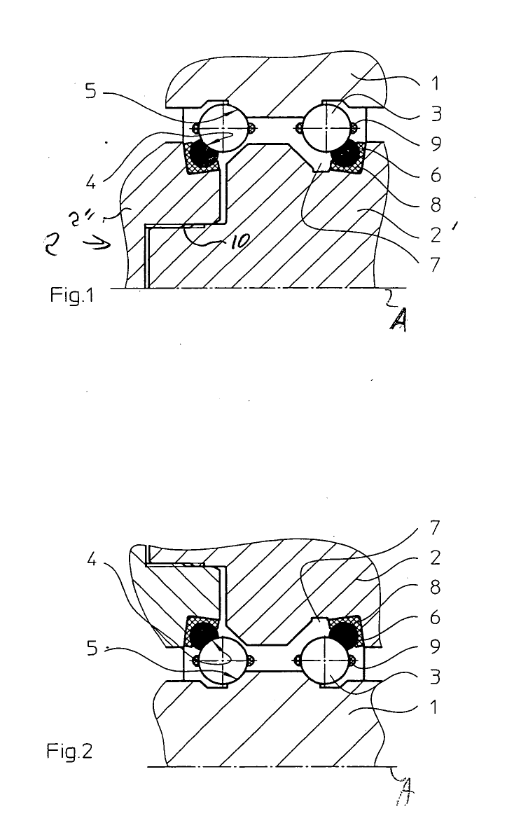

As seen in FIG. 1 a bearing according to the invention basically comprises a part 1 and a part 2, the former a rotor centered on an axis A and the latter a stator shaft carried on the part 1 and also centered on the axis A. The stator part 2 is formed by a pair of subparts 2′ and 2″ that are interconnected at a screwthread 10 so that they can be limitedly displaced axially relative to each other.

The part 1 is unitarily and directly formed with a pair of annular tracks 5 in each of which rides an array of roller elements 3, here balls, secured in a respective standard cage 9. The part 2 according to the invention is formed with a pair of grooves 7 in each of which sits a U-section resilient suction ring 8 holding a harder respective track ring 6 forming a track 4 for the respective array of balls 3. Thus although on one side, each array of balls 3 rides directly on the hardened track of the part 1, on the other side each array is supported via a respective track ring 6 and suction ring 8 on the part 2. The tracks 5 of the part 1 are directed axially away from each other and radially inward, and the tracks 4 are directed axially generally toward one another and radially outward, so that this bearing can resist axial and radial forces.

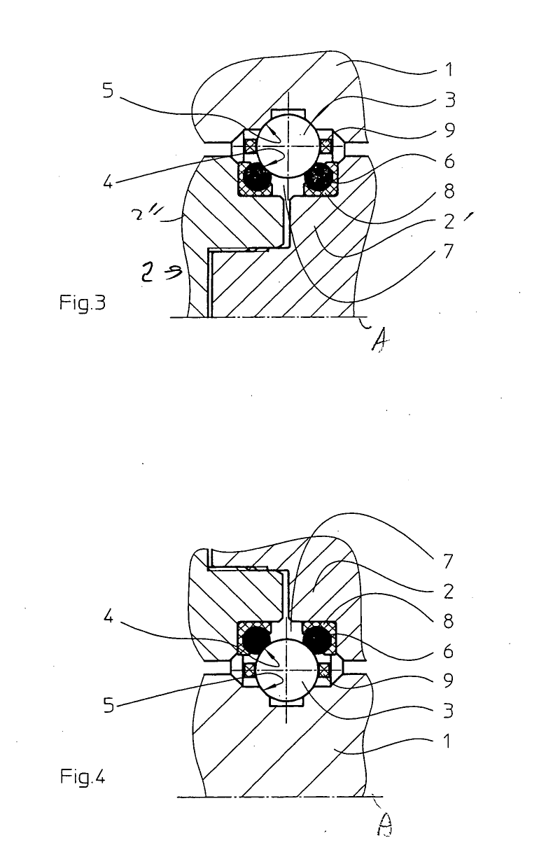

The system of FIG. 2 is identical to that of FIG. 1, except that the stator and rotor are reversed. Thus the tracks 5 are formed on a stationary stator shaft 1 and the rotor 2 is made of two subpart 2′ and 2″ and carries the cushion rings 8 and track rings 6.

FIGS. 3 and 4 show bearings having four instead of two contact lines for a single array of roller elements 3. Here the groove 7 of the part 2 carries a pair of cushion rings 8 and a pair of track rings 6. Similarly the part 1 in formed integrally with two tracks 5 on which the single row of elements 3 rolls. Thus each ball 3 is supported at four points. In FIG. 3 the part 2 is the stator and in FIG. 4 the part 1 is the stator.

1. In combination with a pair of parts rotatable relative to each other about an axis, a roller bearing comprising:
a radially directed and angularly extending annular track unitarily formed on one of the parts and centered on the axis, the other of the parts being formed with a groove open toward the track;
a track ring centered on the axis and formed with an annular track radially confronting the track of the one part;
a cushion ring supporting the track ring in the groove on the other of the parts; and
an annular array of roller elements between and engaging both of the tracks.

2. The roller bearing defined in claim 1 wherein the tracks are hardened.

3. The roller bearing defined in claim 1 wherein the one part is a rotor and the other part is a stator.

4. The roller bearing defined in claim 1 wherein the one part is formed with two such tracks spaced axially apart and the bearing has two such track rings in the groove and two such cushion rings between the track rings and the other part, the array of roller element riding on both tracks of the one part and both track rings of the other part.

5. The roller bearing defined in claim 4 wherein the one part is subdivided axially into two subparts between the two tracks.

6. The roller bearing defined in claim 1 wherein the one part is formed with two such tracks spaced axially apart and the other part is formed with two such grooves spaced axially apart, the bearing having two such track rings in the grooves, two such cushion rings between the track rings and the other part, and two such arrays of roller elements.

7. The roller bearing defined in claim 1 wherein the one part is subdivided axially into two subparts between the two tracks.

8. The roller bearing defined in claim 7 wherein the two subparts are relatively axially displaceable.
